(19) United States
(12) Patent Application Publication
(10) Pub. No.: US 2011/0137580 A1
(43) Pub. Date: Jun. 9, 2011

(54) FLOW MEASUREMENT METHOD AND DEVICE

(76) Inventors: Frank Bartels, Hattingen (DE); Markus Rawert, Coesfeld (DE)

(21) Appl. No.: 12/448,653

(22) PCT Filed: Dec. 19, 2007
(86) PCT No.: PCT/EP2007/011146

§ 371 Date: Jun. 3, 2010

(30) Foreign Application Priority Data
Dec. 29, 2006 (DE) 10 2006 062 552.8

(51) Int. Cl. G01F 1/34; G06F 19/00

(52) U.S. Cl. 702/47; 73/861.42

(57) ABSTRACT

The invention relates to a device and a method for measuring volumetric flow rates of preferably liquid, but also gaseous fluids. A movably mounted membrane, one side of which can fluidically communicate with the pressure of the conveyed medium, is the core of the measuring instrument. Changes in pressure, which occur particularly in pulsating conveying mechanisms (e.g. diaphragm pumps), result in cyclic pressure variations in the measuring chamber and on the measuring membrane. If there is no pulsation because a non-pulsating conveying mechanism is used, the pulsation can be generated by means of an additional pulsating mechanism. The cyclically changing deflection of the measuring membrane can be detected by means of a suitable sensor, particularly a piezo active material that generates a tension when being bent, and can be fed to an electronic evaluation unit, for example. In a particularly advantageous embodiment, the conveying or pulsating mechanism and the measuring device are composed of nearly the same elements and are integrated into a common housing.

The present invention relates to a method for the ascertainment of a fluid quantity delivered by a delivering device as well as to an apparatus for carrying out the same.

The measurement of volume and mass streams is of high interest in many fields of technology. In particular in the control of flow rates, the measurand must be captured by a reliable sensor and transferred to the control unit. The fields of application range from heavy industries (e.g. volumetric measurement of hydraulic liquids in drive systems), automotive industries (air mass sensor, fuel pump control), over process engineering and pharmaceutical industries (control of the mixture ratio during a continuous mixing of different media or substances), electrical and electronics industries (e.g. continuous soldering processes), plastics industries (precise delivery of synthetic granules in the production of endless foils or tubes), medical technology (delivery of blood; dialysis; precise continuous dosing of active agents), to micro and nano technology (e.g. coating of surfaces in continuous processes with layers having a thickness of only a few atom layers).

Generally, it can be assumed that volume flow sensors are used wherever the time course of a delivery quantity (the delivery rate), realized by means of suitable delivery devices (e.g. pumps), must be known.

In general, the media to be measured may be liquids (e.g. water, chemicals, solders, etc.) as well as gases (e.g. air, noble or reaction gases, cooling gases, etc.) or (particulate) solids (e.g. granules, sand, bulk material, etc.). The sensor is subject to specific requirements that depend on the medium to be measured. Thus, it is not possible to design a sensor that is suitable for all media and all fields of application.

The present invention in particular relates to the ascertainment and measurement of fluid streams. A fluid is a matter that is regarded as a continuum. All gases and liquids are fluids. When being subjected to shear stresses, these fluids deform indefinitely. In the passive state, however, these fluids cannot take up any shear stress, but only normal stress, which is specified by a scalar value, the so-called pressure. In general as well as according to the invention, fluids are divided into Newtonian and Non-Newtonian fluids, wherein the classification is based on the functional context of shear stress and deformation velocity that describes the flow characteristics of the medium.

For the selection of the type of sensor, besides the type of medium, the metering range (lowest and highest volume flow to be measured) and the required precision are of particular relevance. The state of the art comprises an almost unscreenable multitude of sensors, covering virtually all fields of technology. However, a demand for optimization often exists with regard to robustness, costs, and precision, in particular at the lower end of the technically reasonable or possible measuring range.

In particular in the area of micro and nano technology, usually smallest amounts of fluids, mostly liquids, are delivered. These are often in the range of nl/min to ml/min. Measurement of such small fluid quantities is a particular challenge because the sensor itself, due to limitations of its miniaturization, has a considerable effect on the entire fluidic system since it is no longer negligibly small compared to the delivery means and the respective volumes. As a result of that, the sensor itself affects the measuring result, by e.g. opposing an additional resistance to the fluid, or by influencing the fluid's viscosity and therefore its flow capability due to significant, i.e. non-negligible warming. In these cases, the sensor itself must be considered as a disturbance. If no other measuring principle with a lower influence is applicable, the degree of influence must be known and considered in the evaluation of the sensor signals. If, for example, the heat capacity of the sensor is known, the energy that is needed to heat it up can be calculated and subtracted from the measured energy. From the difference, the velocity with which the fluid must have passed the heat source can be calculated. Depending on the measuring principle, the influence affects different physical parameters. In particular, sensors can affect the maximum fluid stream and the viscosity and, therefore, the flow velocity of the fluid.

For the measurement of fluid volume flows, the following principles are known from the prior art, whereby not all methods are reasonably suitable for small and smallest amounts:

For the measurement by means of a heating wire, a wire (e.g. platinum) heated by a current is placed into the fluid flow and warms the surrounding fluid. Depending on the flow velocity of the fluid, more or less heat dissipates from the wire. This can be detected e.g. by a temperature sensor that is positioned closely downstream of the heating wire. The volume flow is then derived from the temperature difference captured by the sensor.

In a similar principle, the temperature of the heating element that is located directly at the temperature sensor is kept constant, and the required power serves as measuring parameter (e.g. air mass sensor in motor vehicles).

A particular drawback of the heat wire measurement is that depending on the setup, a considerable amount of energy is consumed for the warming of the fluid. Since most micro systems, in particular with respect to the increasing mobility, only have a closely limited supply of energy, consumption by conversion into heat is undesirable. Also undesired is the warming of the fluid itself, since in certain applications temperature sensitive liquids or substances (e.g. medical agents) are delivered that can be negatively influenced by the heating. Furthermore, the necessary “self cleaning” of the wires by short-time high energy pulses that can lead up to a red heat warming, resulting in burning of dirt particles and deposits by way of pyrolysis, cannot be used in such systems due to the often temperature sensitive materials (plastics) of at least some components.

Furthermore, this type of measurement only functions sufficiently well for continuous, pulsation-free streams. If the stream pulses, as it is the case for delivery devices such as, for example, membrane or piston pumps, the heat transfer to the sensor is no longer uniform. Finally, also turbulences can occur, by which the heat is dissipated in an unpredictable manner in the channel, so that the result is distorted and cannot be reproduced.

Often, a determination of the flow velocity takes place by the use of the known physical aspects that describe the relation of flow velocity and fluid pressure. For the ascertainment of the pressure at one or several locations, different pressure sensor types are used that provide the static, the dynamic or the total pressure at the measuring site, depending on the design. For this, both absolute as well as differential pressure sensors can be used.

If the pressure difference between two sites of a fluidic system and the according geometry is known, it is possible to calculate the volume flow streaming between these sites.

In a common embodiment, a differential pressure sensor comprises a chamber that is divided by a membrane into two semi-compartments that are hermetically separated from each other. Upon exposing a pressure to one of the two semi-compartments, a change of the curvature of the membrane occurs that can be transferred into an electrical parameter by means of suitable devices. If one of the semi-compartments communicates with the fluid and the other with the environment (open chamber), the interior pressure of the fluid channel is measured against the environmental pressure, since the amount of curvature corresponds to the pressure difference between the inside and the outside.

Alternatively, also both compartments can communicate with the fluid, wherein they are coupled with sites of the fluid carrying channel that are spaced apart from each other. Then, the differential pressure of these two sites is measured.

In an alternative, the two measuring sites are located in a defined distance to each other at the walls of a channel or a tube with a two-step diameter. By measuring the pressure drop (“differential head”) along the measuring length comprising both cross-sections, the volume flow can be calculated in consideration of the respective known channel cross-section. The relation between volume stream and pressure difference is described by the so-called Torricelli equation.

The general principle of this measurement is referred to as the so-called Bernoulli principle, which states that a cross sectional tapering of a streaming fluid is accompanied by an increase of velocity. This is derived from the more general Bernoulli equation, according to which the sum of all energy forms of a streaming fluid is always constant at different sites of a flow path. Furthermore, this relates to Bernoulli's statement, according to which the total pressure of a fluid is the sum of static and dynamic pressure.

However, for the measurement using differential pressures, the channel cross-section must sometimes be reduced significantly in order to achieve a sufficiently high differential pressure for low flow velocities and therefore volume flows. A restrictor that is therefore artificially introduced into the system may reduce the total performance of the pressure generating delivery device. In particular in the case of smallest volume flows and/or miniaturized pumps, this principle is therefore unsuitable.

An absolute pressure sensor compares the pressure to be measured with a fixed value. In general, it therefore comprises two chambers that are hermetically separated from each other by a membrane, from which one is in contact with the fluid to be measured, and the other forms a hermetically sealed compartment by means of a closed housing. This compartment has a pressure that has been pre-set during fabrication of the sensor and that normally is not changeable. In the case of temperature variations, these can be detected for example by an integrated temperature sensor and compensated by calculation.

If two sensors of this type are placed at two different locations of a fluid carrying channel, the differential pressure between the two measuring sites can be determined by subtraction of both total pressures. Further analysis corresponds to the aforementioned case.

In another alternative, the pressure drop in a straight or curved tube due to friction is used for determination of the volume flow. The principle upon which this is based on is described via the boundary layer theory for laminar flows by the law of Hagen-Poiseuille. Here as well, different types of pressure sensors can be used.

For the measurement by means of differential pressures of this variant, the drawback of a tapering channel cross-section no longer applies. However, a certain friction in the fluid is necessary, since otherwise the pressure drop between the measuring sites is too small or the measuring length must be very long, respectively. Both drawbacks are of particular relevance with respect to miniaturized systems that offer short distances and already low delivery rates.

The use of total pressure sensors is based on the well-known relation of the proportionality of flow velocity and dynamic pressure. The total pressure is composed of a static and a dynamic pressure fraction (Bernoulli's law).

In order to determine the flow velocity by means of this principle, a corresponding pressure sensor must either determine the dynamic pressure directly, or it must ascertain the total pressure as well as the static pressure. The missing third pressure (dynamic pressure) can then directly be calculated by subtraction. This sensor as a whole can comprise several individual pressure sensors that are responsible for the ascertainment of the individual pressures.

A practical example of a design of a total pressure sensor is e.g. the so-called Pitot tube, an L-shaped tube that is in particular used in aviation. When further developed as a Prandtl impact tube, it comprises on one hand the main opening that points in flow direction, by which the sum of wind pressure (dynamic pressure) and static pressure (environmental pressure) can be ascertained as a total pressure. Furthermore, the tube comprises lateral boreholes by which only the static pressure surrounding the measuring tube is ascertained. By means of a suitable differential pressure sensor, whose both compartments are respectively subjected to either one of both pressures, the flow velocity of the fluid can then be determined by ascertainment of the pressure difference between static and total pressure. Of course, two total pressure sensors can also be used instead of one differential pressure sensor.

In particular, such sensors are common in process technology and can be used for a multitude of media. There, the common name is flow meter probe. They are less suitable for smallest amounts of fluid, since the probe must be small with respect to the channel diameter such that the pressure and therefore the flow conditions are not influenced by itself. Due to the poor possibilities for miniaturization of the setup, no micro sensors are known that are based on the principle of the Pitot tube or the Prandtl impact tube.

If elements are located in the volume stream that oppose a certain resistance to it, the resulting forces effect a deformation of the elements. If these elements are suited to provide their deformation e.g. via a change of their electrical resistance for a measurement, it is convenient to calculate the fluid flow effecting this deformation by means of so-called strain gauges.

In particular in very small channel cross-sections, however, strain gauges in the volume stream considerably constrict the free fluid transport if they are oriented perpendicular to the flow direction. Furthermore, the delivery rates as well as the resulting forces that can be used for the strain gauges are often very small in such systems. An insufficient sensitivity of the measurement is the result.

When measuring using mechanically moved components, these are inserted into the fluid stream e.g. in the form of rotating paddles that are put into rotation by the stream, so that the rotational speed can serve as a measurand that is approximately proportional to the volume flow. If each of the individual paddle volumes fill the channel over its entire cross-section, no fluid can pass the cross-section without putting the sensor in motion (suppression of “air bleed”). Therefore, the measurement becomes independent of parameters such as viscosity, temperature, and flow velocity. Examples are volume meters in water meters or fuel dispensing systems of older types. Such measurement instruments are known as “oscillating-piston flow meters”, “Woltmann current meters”, or jet meters.

Another method of volumetric measurement uses a flap gate that is opened in response to an increasing volume flow. The flap position is then analyzed electrically.

Already known from the times of the Roman Empire are Venturi meters, by which the volume flow is mechanically impeded and the differential pressure is measured along the obstruction. Similar functioning instruments measure the strength of turbulences at obstacles (vortex meters).

However, mechanically moved components generally have the drawback of mechanical wear. A further problem, in particular with respect to micro systems, arises from the process related large “relative” tolerances. While for example gaps of 10 μm between a paddle wheel and the channel wall are unproblematic for a channel width of several centimeters, a gap width of similar magnitude results in remarkable secondary flows when micro-channels with partially below 100 μm are used. In extreme cases the tolerances lie in the same range as the channel cross-sections themselves. This results in drawbacks both due to the mentioned secondary flows, as well as to the increased mechanical wear (e.g. for shaft-hub connections). Furthermore, the miniaturization possibilities for mechanical parts are strongly limited so that such systems can not be used, at least for the ascertainment of small and smallest flow rates.

If the medium to be measured is a conducting fluid (e.g. water) it can be regarded as a conductor that moves in a magnetic field which is applied from the outside. According to Faraday's law of electromagnetic induction, a potential difference is thus generated that is proportional to the flow velocity of the fluid and can be captured and measured by means of suitable electrodes.

However, these magnetic meters have the main drawback of a considerable power consumption that is needed for generation of the magnetic field. Furthermore, the construction of a miniaturized coil in accordingly small dimensions can—if at all—only be realized with considerable efforts.

Ultrasound counters measure the difference in the propagation speed of ultrasound wave pulses that are emitted in a certain angle inline with or opposing to the flow direction. The mean flow velocity along the ultrasound path can be derived from the time difference.

Furthermore, the determination of the Doppler shift of an (ultra)sound beam reflected by a fluid can also be used for measurement of the fluid velocity.

However, ultrasound counters are rather suitable for larger channel cross-sections since the transducers required therefore must be small with respect to the channel, because otherwise, no sufficiently precise ascertainment of the flow velocity is possible.

The Coriolis mass flow measurement is performed such that an elastic tube (straight or curved) is put into transversal oscillation by means of a mechanical device. If no fluid streams through the tube, the oscillation pattern is different than for flow velocities greater zero. The change of the oscillation shape is directly connected to the mass flow of the fluid. A simple multiplication of the volume flow with the density of the fluid is no longer correct, when there are air bubbles or density distributions that are not constant over the cross-section. Therefore, the Coriolis measurement is also not suitable as a volumetric measurement.

Furthermore, the Coriolis mass flow measurement is difficult to apply to miniaturized systems. The construction of a freely oscillating tube as well as the development of the vibration and also the measurement of the oscillation shape can only be realized with considerable efforts and down to a minimum size.

By means of suitable imaging devices that ascertain the movement of natural contaminations or added so-called tracer particles in a streaming fluid, it is possible to derive the volume flow on which the movement speed is based if the diameter is known (“delay time method”). Depending on the type of the fluid, the flow profile (e.g. parabolic profile for Newtonian fluids) must be taken into account.

An advantage of such measuring principles is the possibility of particularly measuring media of higher viscosities without having to oppose a resistance to the fluid flow. A drawback is the necessity of particles being transported through the fluid, and the fact that a certain transparency of the fluid is required.

In particular for gases the effect of a wire placed in a fluid stream being set into oscillations can be used, wherein the frequency is proportional to the mean flow velocity and therefore to the volume flow rate. Herein, the oscillations are generated by mutually developing vortices dissipated from the stream. By means of so-called vortex meters, both the oscillations of the wire as well the pressure fluctuations produced by the periodic vortex dissipations can (e.g. capacitively) be ascertained and further processed.

This measurement principle is universally applicable to fluids, gases and vapors, and primarily has the advantage of being free from drift, so that additional calibration is obsolete over the entire life cycle.

However, it principally fails for channels below a limit of several hundreds of micrometers of width or diameter, respectively, since then only laminar flows develop.

With regard to the usage of pressure sensors for the ascertainment of a fluid quantity, reference is made e.g. to the following prior art.

U.S. Pat. No. 6,871,551 B2 e.g. discloses a combination of delivery device and measuring means for the measurement of the approximate delivery volume, wherein the delivery device and the measuring means are spatially separated from each other. A displacement pump is used as delivery device, while as measuring means, a pressure sensor or a strain sensor is proposed that is applied to a support. Upon operation of the pump, the fluid is transported through an elastic tube, so that the resulting pressure change can be ascertained by the sensor at the wall of the tube. From the ascertained pressure change it shall be possible to calculate the fluid quantity that is delivered per time unit. However, the described method can only be used above a certain range of volume flow (≧ ml/min), since the distortion of the tube caused by the delivery or its measurement, respectively, is only detectable with sufficient precision with relatively high pressures (200 hPa or 0.2 bar overpressure).

A similar solution is proposed in U.S. Pat. No. 5,701,646, wherein the method is only described for the detection of the presence of a fluid in a delivery system, but not for the ascertainment of the fluid quantity. The pressure sensor explicitly comprises a piezoelectric layer by which the distortion of the elastic tube caused by the delivery can be ascertained and provided in the form of electrical signals.

A further method for the measurement of the fluid flow of liquid (not gaseous) media is disclosed in US 20040247446, wherein the above-mentioned principle of heat dissipation or the heat transfer from a heat source to a heat sensor, and also the measurement of the fluidic pressure by aid of e.g. a piezoresistive thick film sensor is used. While the flow rate is determined by means of the heat sensor, the pressure sensor only serves for the detection of reaching a maximum pressure, but not for the determination of the flow rate. Because of the combined heat measurement, the method is not suitable for gases and exhibits the above-mentioned drawbacks of such a measurement.

The presently described methods of the state of the art that use pressure sensors for the ascertainment of a delivered fluid quantity firstly have the common drawback that only continuously and uniformly transported fluid quantities can be ascertained with sufficient precision. Further drawbacks relate to the significant costs of the system components as well as to the possibility of their integration into systems that are to be used in the field of microsystem technology and nanotechnology.

Object of the present invention is therefore the provision of a method for the ascertainment of a delivered fluid quantity that can be carried out by usage of cost effective components and that provides reproducibly precise results in particular for very small delivery rates. The object further comprises the provision of suitable devices and components for carrying out the method according to the invention.

For the solution of the present task, the method according to the main claim and the apparatus according to claim 6 are provided. Particularly preferred embodiments are provided in the respective dependent claims. The method according to the invention serves for the ascertainment of a fluid quantity that streams pulsating through a channel by comparison of the profiles of at least two signals, which are related to a pulsational pressure change of the fluid stream and which are ascertained either at the same time at non-identical sites or at different times at one site of the fluid stream.

The method according to the invention is carried out preferably by the following steps:
A signal that represents the pressure pulsation of the fluid is ascertained by aid of the measuring means and, if necessary, transformed in an electronically processable form.
Standard values or profiles are generated from the ascertained signals.
The profiles or standard values are compared with each other.
The volume flow of the fluid can be determined by comparing the profiles using suitable methods.

The experiments that have lead to the present invention show that even smallest amounts of a fluid can securely be ascertained as long as the fluid pulsates and the pulsational pressure change can be ascertained and/or is known. Furthermore, experiments have surprisingly revealed that inhomogeneities within the fluid stream, e.g. resulting from dragged air bubbles, can securely be detected due to the high sensitivity of the method according to the invention, and, where required, be considered or even eliminated.

Wherever interchangeable, the unifying expression “actuator” is used in the following instead of the differentiation between pulsation device and pump.

Furthermore it shall be understood that the term “system” or “flow sensor” relates to the entire setup comprising pulsation or pumping device and sensor, whereas “sensor”, “pressure sensor” or “detector” merely identify the embodied unit for the ascertainment of the fluid pulsation pressure.

As set forth in the following detailed description as well as in the figures, the presently used term of a “profile” designates the course of a signal within one pulsation period and comprises “parameters” such as in particular positive and/or negative amplitude, slope of the positive and negative edges, and time of the different zero crossings.

The method according to the invention serves for the ascertainment of a fluid quantity that streams pulsating through a channel by comparison of the profiles of at least two signals, which are related to a pulsational pressure change of the fluid stream and which are ascertained either at the same time at non-identical sites of the fluid stream or at different times at one site of the fluid stream.

According to the invention, the curve progressions of the “profiles” and/or single or multiple parameters thereof are used for the comparison. The profiles represent the smallest unit of the signal courses that are periodically repeated due to the pulsation as long as the system is in a stationary state. This state is characterized by pressure patterns and therefore profiles, which follow from a sequence of substantially identical pulses or from the resulting pressure patterns, respectively.

According to a preferred embodiment of the method according to the invention, at least one of the profiles can be provided by so-called “standard values”, wherein these standard values originate from earlier measurements or simulations.

For carrying out the method according to the invention at least a first and a second signal are thus required in order to generate the respective profiles and to subsequently compare them with one another.

According to the invention, the first signal is provided by (a) the signal for the control of the pulsation device, by which the fluid quantity in the channel is put into pulsation, or (b) the signal of a sensor detecting the pressure changes of the pulsating fluid, or (c) standard values, wherein these for example originate from a simulation of the fluidic system or from previous measurements and subsequent generation and storage of the standard values. According to the invention, a second signal is provided by a pressure sensor that is located downstream.

By comparison of the profiles or the parameters characterizing them, the quantity of fluid that streams through the channel can be derived by different methods. For example, mathematical methods or simulation of the system can be used for this. A further application variant of the method according to the invention consists in the comparison of the current profile or current standard values with such profiles or standard values that have been recorded before and whose corresponding fluid quantities are known. The determination of the quantities of such comparison profiles or comparison standard values can be performed by using other methods, e.g. by weighing.

According to a preferred and particularly advantageous embodiment, the profile comparison can be performed for the detection of disturbances in the fluid stream. These disturbances particularly relate to gas bubbles or to improperly working delivery devices. Such disturbances can thus securely be detected by comparison of a profile that corresponds to the desired operation mode with a currently recorded profile that corresponds to the disturbed operation mode. If an attempt is made to re-establish the proper working mode by means of suitable actions, the success of such actions can be monitored in real-time by the method according to the invention.

Furthermore, an apparatus is provided for carrying out the method according to the invention. This apparatus serves for the provision and, if desired, the further processing of the signals 1 and 2 described herein.

The apparatus according to the invention serves for the ascertainment (detection) of a fluid quantity that streams pulsating through a channel by comparison of the profiles of two signals, which are related to a pulsational pressure change of the fluid stream and which are ascertained at the same time at non-identical sites of the fluid stream or at different times at one site of the fluid stream, wherein the apparatus comprises at least one detector for the ascertainment of an input quantity and for the transformation into an output quantity, which is built by an elastically deformable membrane that is fixed with respect to the fluid carrying channel and that is in contact with the fluid at least along one side, wherein the membrane is fluidically sealed along its circumference against the channel.

According to a particularly preferred embodiment, the apparatus further comprises an evaluation unit for further processing of the output quantity. The evaluation unit serves for the generation of profiles according to the invention from each input quantity, as well as for their further processing in form of a comparison with additional profiles, as well as, if desired, for the display or transfer of the data resulting from the further processing.

The evaluation unit can be allocated to the detector as an external component, or preferably as an integrated component.

The input quantity that is to be ascertained by the detector according to the invention is preferably the pressure of the fluid quantity streaming through the channel at a certain measuring site.

In a preferred embodiment of the detector according to the invention, the output signal of the detector or of the detectors is present in a form that can easily be transferred into an electrical signal, such as e.g. an optical, acoustic, mechanical, magnetic, or capacitive signal. In a particularly preferred embodiment, the output of the detector directly provides an electrical signal, i.e. a current, a voltage, or a change in resistance.

According to the invention, the at least one detector is provided in the form of an elastically deformable membrane that is stationary with respect to the channel and that is at least on one side in contact with the fluid to be measured, so that it is elastically deformed or deflected by pressure changes of the fluid. According to the invention, the membrane's default deflection is zero, characterizing the state in which the pressure is substantially identical on both sides of the membrane. As membrane materials, principally all materials that are commercially available can be used. Preferably, such materials can be used that exhibit a Young's modulus that is significantly lower than the one of the material that surrounds the membrane. Furthermore, such materials are preferred that additionally meet specific requirements such as fatigue strength, temperature strength, tightness, etc.

In a particularly preferred embodiment, the apparatus according to the invention comprises the elastically deformable membrane of the at least one detector in the form of a piezoelectric layer.

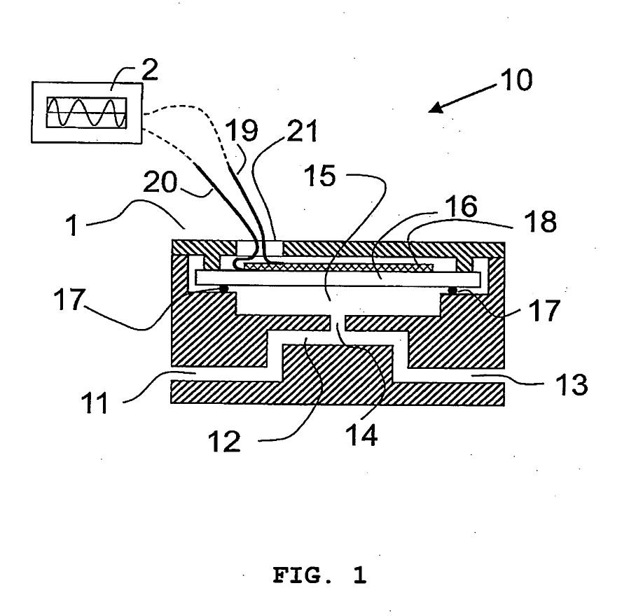

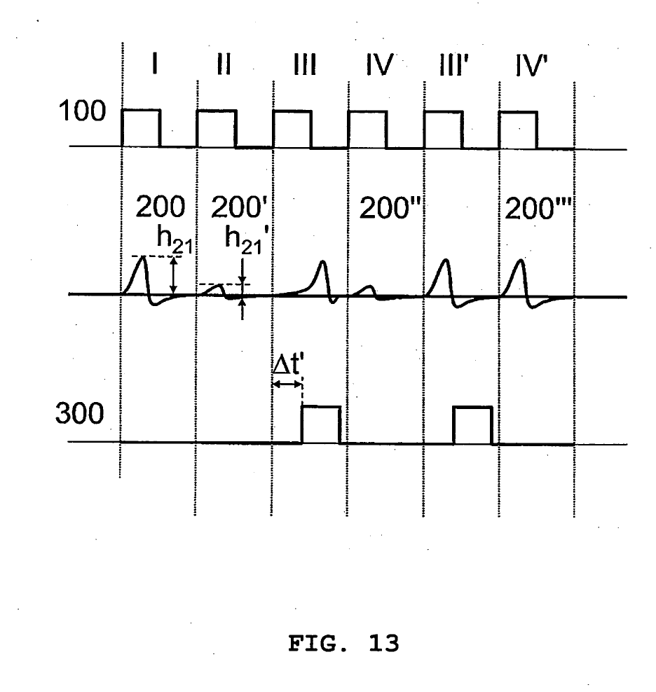

According to an alternative particularly preferred embodiment of the detector, a layer of piezoelectric material is seated onto the fluid-opposing side of an elastically deformable membrane that itself does not consist of this material. This layer comprises on each of its two sides one electrode that allows a simple leading-off of the signal via a conductor that is mounted to each electrode, or, alternatively, that allows the input for the power that is necessary for a temporary pulsation operation described herein below (cf. FIG. 1, FIG. 13).

An advantage of these particularly preferred embodiments is the direct transformation of the pressure that is present at the membrane (the input quantity) into an electrical signal.

In a most particularly preferred embodiment the elastically deformable membrane shows the characteristics of an actuator. Therein, application of an electrical voltage to the electrodes of the pressure sensor membrane effects a change of its curvature, resulting in a movement of the fluid that borders the membrane, which can in particular be advantageously used e.g. for supporting the pulsation device in the driving out of gas bubbles.

The apparatus according to the invention further preferably comprises a pulsation device for the generation of the pulsation of the fluid quantity streaming through the channel that is necessary for carrying out the method according to the invention.

In a particularly preferred embodiment of the apparatus according to the invention the pulsation device comprises a piezo-actuated membrane that, in a most preferred embodiment, comprises the same constructive features as the detector that is used for the ascertainment of the courses of the pressure curves according to the invention.

The invention is illustrated in detail herein below.

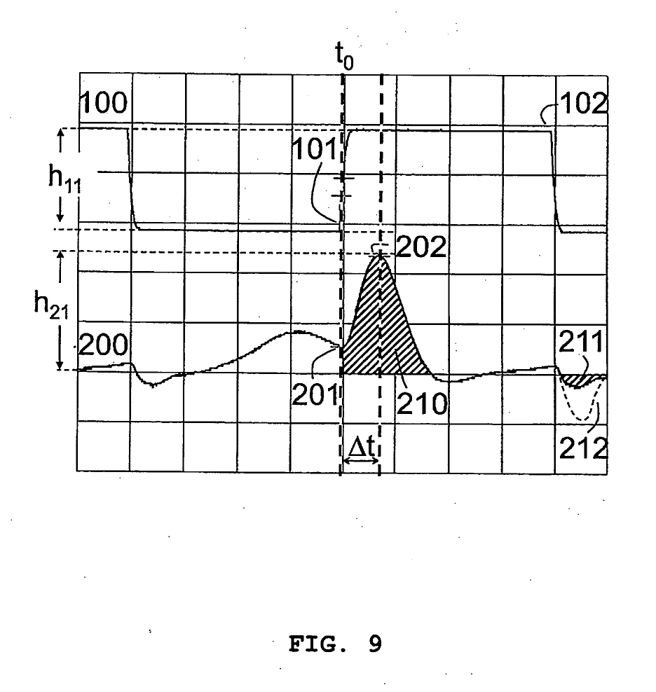

As set forth above, the first signal, according to a preferred embodiment, is provided by the control of the pulsation device, such as e.g. a pulsating pump, or by a sensor used for the ascertainment of the pressure state of an already pulsating fluid, while the second signal is generated by a pressure sensor that is located downstream. Further signals can be generated by further pressure sensors that are arranged in the flow path of the fluid channel. The process of comparing two signals that are recorded at the same time but at different sites is exemplarily depicted in FIG. 9 and will be explained in detail herein below.

The first signal that represents the pressure state of the pulsating fluid stream can, alternatively, also be provided in the form of a standard value, which can be stored in an evaluation unit according to the invention and considers the parameters of the complete system such as in particular the type of fluid, the diameter of the channel, and/or the characteristics of the pulsation source. In this case as well, the second signal is generated by the pressure sensor that is located downstream.

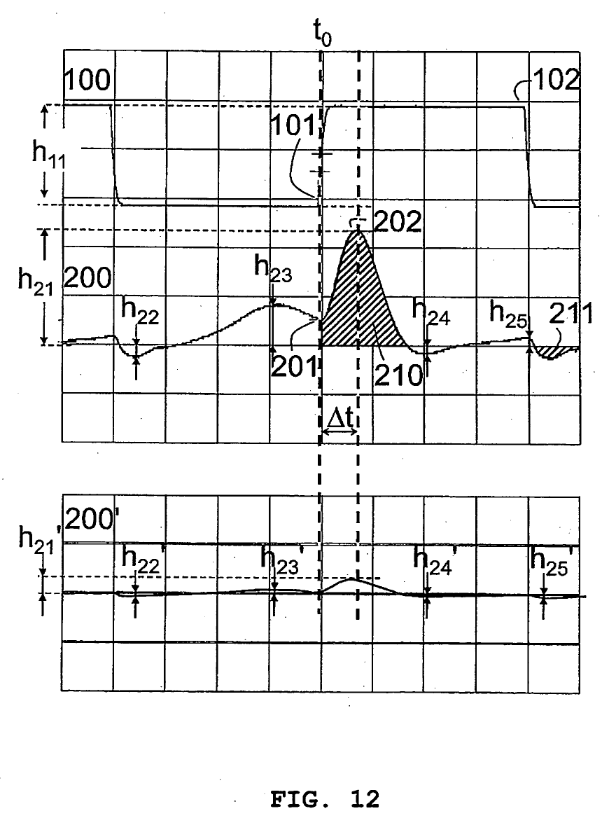

If the first signal that is allocated to the pressure pattern of the pulsation source is not already available e.g. in the form of a driving signal of the actuator that produces the pulsation, it can as well be gained with the sensory means that generates the signal 2 itself, if the profile that is gained in such a manner and corresponds to signal 1 is subsequently stored in order to be compared later with the updated profile of signal 2 that is recorded time-shifted. Such an apparatus is e.g. depicted in FIG. 1, if the measuring and evaluation unit shown there provides the possibility of storing the signal 1 that is gained by the sensor. The usage of a previously stored signal as the basis for a comparison with a signal that is recorded at a later time is exemplarily depicted in FIG. 12 and will be explained in detail herein below.

Thus and independent of the actual type of embodiment, at least two signals, according to the invention, are always subjected to a comparison or a balancing, wherein the signals are characterized by certain profiles.

These profiles of the at least two signals are being compared with each other according to the invention. This is preferably effected by plotting both signal courses over each other for at least one complete pulsation period and by evaluating respective offsets. According to a preferred embodiment this comparison can take place automatically in an integrated or external provided control and/or evaluation unit.

Preferably, the first signal is ascertained as close as possible to the pulsation source, and the second signal is ascertained downstream of the pulsation source. In an alternative of the described embodiment the measuring system comprises further measuring means that preferably also allows the pressure detection upstream of the pulsation device.

Thus, the present invention also provides a reliable basis for the detection of disturbances in the fluid stream. In this context, reference is made to FIG. 12 as well as to the corresponding description.

Finally, it is possible according to the invention to react to the disturbances described hereinbefore by temporarily increasing the delivery rate of the system being affected by the disturbance, so that the probability of an elimination of the disturbance by driving-out is increased. This is exemplarily illustrated in FIG. 13.

The method according to the invention provides the following procedures for determination of the volume flow from the measuring signal(s) or the profiles derived thereof:
recordal of reference curve patterns as standard values together with the corresponding known volume flow quantities, and comparison of the reference curves with the actually recorded measurement curves by means of so-called “look up tables”;
use of a simulation model that e.g. uses simplified circuits from the field of electrical engineering that are equivalent to fluid technology so that a real-time correlation of the measurement data with the simulation model is enabled, thereby calculating the volume flow;
calculation of the volume flow on the basis of parameters that are known from the measurement or the construction, such as pressure, geometry, viscosity, pressure pattern, control signal for the pump, etc., wherein corresponding systems of differential equations have to be formulated and solved in real time.

For carrying out the method according to the invention, different alternative devices are provided according to the invention. These devices serve for the ascertainment of pressures and/or pressure fluctuations within a fluid channel and, if so, for their electronic processing, in particular for the extraction of the profiles and/or standard values that are necessary for carrying out the method according to the invention, as well as, if necessary, for their storage.

All those designs are preferred that allow for a cost-effective and space-saving production of the system. Equally preferred are variants that require a most possible low number of different components. Furthermore, such designs are preferred that require a most possible low number of process steps for the production of the system. In the following, these embodiments are denoted as preferred, particularly preferred, or most preferred embodiments.

According to the invention, at least one means for the ascertainment of the pressure pattern of the signal 2, as well as a further means for the ascertainment of the pressure pattern of the signal 1 are required, if the latter cannot be provided otherwise, e.g. by use of the control signals for the pulsation source, or by use of standard values previously stored in a storage device according to the invention.

All those means are preferred for the detection of pressures and/or pressure fluctuations that present the signal in an electronically processable form, so that the method according to the invention can be applied to it. Particularly preferred are therefore sensory means, by which the measurement signal is preferably provided directly as an electrical quantity (current, voltage, or change in resistance). Particularly preferred methods are those in which the change of the output signal is almost proportional to the change of the measurand. For example, this is the case for pressure sensors with a mechanically deformed membrane, since its curvature changes approximately proportional with the pressure difference of both sides of the membrane.

Accordingly, a particularly preferred embodiment of the means for the detection of pressure fluctuations is represented by a stationary, but elastically deformable membrane that is in contact with the streaming fluid. In the following, alternatives are given that concern the relation between such a membrane and its surrounding material.

In order to keep the detector membrane stationary, it is preferably along its circumferential edge connected with the material surrounding it, wherein the membrane's freedom of movement must be retained in at least one degree of freedom, preferably perpendicular to the membrane surface. Thereby, the connection can be realized e.g. by restraining, clamping, or also by simple local reduction of the thickness of the surrounding material.

The membrane can be restrained immobile, or, in a preferred embodiment, it can be flexibly mounted.

In a first simple embodiment the membrane forms part of the outer wall of the channel, which is streamed through by the fluid to be measured. Preferably, the close vicinity of the membrane is as far as possible inelastic, so that its deformation upon a pressure change in the channel's interior can be neglected versus the change of the membrane's curvature.

In an alternative embodiment, the membrane is located at a separate and as far as possible stiff housing that encloses a cavity, and forms part of the outer wall of this housing. The interior of this housing is in fluidic contact with the fluid to be measured.

In a third embodiment, the membrane is positioned in the interior of the housing and divides its interior in two compartments that are separated fluidically sealed from each other.

One of these compartments is in fluidic contact with the fluid to be measured, while the other compartment can be entirely closed, or it can have fluidic contact by means of suitable fluidic connection elements to the outside (cf. FIG. 1), or to a different site of the fluid to be measured. This latter embodiment enables the ascertainment of two signals by means of one single pressure sensor, thus representing a particular advantage over the prior art.

Additive processes (layer compositions) as well as subtractive (abrasive) processes, and combinations thereof can be used as production processes for a housing of a detector of the apparatus according to the invention, wherein the detector is oriented in a more planar shape as depicted in FIG. 1. Particularly preferred are devices made of polymeric layers that can be produced e.g. by means of injection molding, laminating, or laser processing, and that are connected to each other by joining processes such as gluing, clamping, laser welding, or solvent bonding.

In this context it is desirable to minimize the amount of energy that comes from the pulsation device, is transferred by means of the streaming fluid, and flows into the deflection of the separation and sensor membrane in order to displace the same and thereby to generate the signal. Although the energy that is stored in the elastic membranes is released during their re-deformation (elastic spring), this is always accompanied by a certain loss of friction heat that is generated e.g. at the elastic support of the separator membrane. The same is true for the joining gaps that are present more or less frequently depending on the design, in which friction and therefore energy losses occur upon recurring expansion of the housing. Therefore, the stiffness of the complete system, but in particular the one of the sensor device, is selected as high as possible.

Object of a detector constructed according to the invention and e.g. as mentioned above is the ascertainment of the fluid's pressure fluctuation, as well as its transformation into an output value that preferably is an electrical signal. Since the pressure fluctuation of the fluid results in a change of curvature or travel (summarizingly termed membrane deflection herein below) of the elastically deformable membrane it must be ensured that this curvature is transformed into an electrical signal which can unambiguously be related to the curvature.

All methods known from the art can be used as sensory means for the ascertainment of the membrane deflection, which preferably is approximately proportional to the pressure change. Such methods can for example be selected from:
optical methods, in which a reflecting, flexible layer is seated on the fluid-opposing side of the separator membrane that differently scatters an incidencing light beam in response to the membrane's curvature;
optical methods, in which a reflecting, but substantially rigid layer is seated on the fluid-opposing side of the separator membrane that deflects an incidencing light beam in different directions depending on its position;
optical methods that can determine delay time differences resulting from changing distances;
acoustical methods that measure distances by means of e.g. the Doppler effect;
mechanical methods, in which the curvature is transformed by means such as rods, levers, hinges etc. into a linear or rotatory motion that is easy to measure and can then be further processed electrically;
electrical methods that e.g. derive the change in resistivity of the membrane's upper side that extends upon curvature by means of sliding contacts or other suitable principles;
magnetic methods, in which separator membrane and housing form a combination of moving coil and magnet, so that the relative movement of both elements can be measured by electromagnetic induction in the coil;
magnetic methods that make use of the Hall-effect; and
capacitive methods, in which e.g. the upper side of the separator membrane and the inner side of the housing are coated with charge-carrying layers, so that these form a capacitor whose capacity changes upon change of the distance.

Particularly preferred are, however, methods based on a piezoelectric layer that is seated on the fluid-opposing side of the membrane and firmly fixed to the same.

According to a preferred embodiment, the detector membrane is identical with the piezoactive layer. According to another preferred embodiment, the piezoactive layer is seated on the elastically deformable membrane that consists of a different material, and according to a particularly preferred embodiment, it is firmly fixed to the same.

If only one side of the membrane is in contact with the fluid, the piezoactive layer is preferably located on the side that is opposing the fluid. If both sides are in contact with the fluid, it can be located in an intermediate layer of the layered membrane.

This piezoactive layer further comprises on both sides at least one electrode for picking-off and transmitting the voltage to a measuring and evaluation unit. In the preferred case of a compartment that is open towards the outside, the electrical input leads of the electrodes can be guided through the existing opening to the exterior.

Typically, the electrodes can be produced by means of suitable vapor deposition processes at the appropriate locations. However, also other methods can be used, such as e.g. adhesive bonding of conductive layers, or selective removal of large-scale covers, as well as using conductive ceramics that can e.g. be activated by laser irradiation (so-called Molded-Interconnect-Device-/MID-technology). The following variants are particularly preferred with respect to the form and position of the electrodes:
The electrodes for voltage measuring are positioned as stripes at the membrane side that is opposing the fluid.
The electrodes are located in the interior of the membrane in a sandwich-like setup.
The electrodes consist of thin conductive paths made from gold, copper, or other conducting or semi-conducting materials.

Preferably, the apparatus according to the invention can further comprise a pulsation source that is necessary particularly if the fluid quantity to be measured is not already pulsating in a processable form.

In a preferred embodiment, the pulsation source can comprise a piezo-actuated membrane, whose control signal can be used for gaining the signal 1, as long as the control signals of the pulsation source are freely accessible.

In a further preferred embodiment, the apparatus according to the invention can comprise a delivery device in form of a pump that particularly preferred is a piezo-actuated membrane pump.

In a most preferred embodiment, the pulsation source together with the pressure sensor unit(s) can be integrated in a common housing.

The apparatus according to the invention can further comprise an evaluation unit that serves for the generation of the profiles from the detector signals as well as for their electronic processing, and that, if applicable, additionally provides one or several standard values.

The evaluation unit can also comprise a storage unit, particularly if either only one detector unit is present and the method according to the invention is performed by comparison of two profiles that are ascertained at different times, or if the continuously updated profile is compared with standard values gained before.

The evaluation unit can further comprise a driver unit for a preferred detector that is temporarily used according to the invention as actuator, as long as the detector is constructed by use of piezoelectric materials.

Thereby, the evaluation unit can be located in a separate housing, although it is particularly preferred that it can be integrated in a common housing together with one or more elements of the apparatus according to the invention.

The present invention ensures that the measurand is present in a form such as a current or a voltage that can easily be processed and that is highly compatible with standard electronics (measurement and control technology), whereby cost-intensive conversion, amplification, etc. can be omitted.

The response time of the detectors used according to the invention is so short that it is possible to ascertain a single pump cycle in a sufficiently fine and time resolved manner.

Besides the ascertainment of the fluid quantity, the comparison of the ascertained signals or of the profiles derived therefrom can be used to determine the flow direction of the fluid streaming through the channel.

A further advantage of the present invention is based on the fact that, depending on the embodiment, only one single pressure sensor is required for the volumetric measurement, since the relation between actuator control and sensor measuring signal instead of the pressure difference between two measuring sites is used for the determination of the volume flow. This represents an important difference to the state of the art.

Finally, a particularly preferred alternative of the detector as used in the invention can temporarily be used without much effort as an actuator in order to e.g. additionally provide an increased delivery rate of the complete system. This e.g. also enables gas bubbles that otherwise would be stuck in the system to be transported.

In a preferred embodiment the present invention provides the apparatus according to the invention to be integrated into the housing of a delivery device or vice-versa, whereby a combined system of delivery and measurement device can be produced in a cost-effective manner.

Furthermore, it is particularly pointed out that the pressure sensor and the pulsation device according to the invention can be fabricated with virtually identical production techniques, as long as the pulsation device is based on a piezo-actuated membrane.

In the following, preferred embodiments of the system according to the invention are explained in more detail by referring to the figures, wherein the terms “detector” and “pressure sensor” are exchangeable.

FIG. 1 shows a sectional view of the assembly of a preferred embodiment of a pressure sensor system of the volume flow sensor 10 according to the invention, which serves for the recordal of pressure patterns and their transformation into electrical signals.

The medium to be measured streams through an inlet 11 into a measuring channel 12, and from there to the outlet 13. The pressure within the measuring channel is also present in the measuring chamber 15 by means of a cross channel 14. The pressure acts on the separator membrane 16 and bulges it upon over pressure in such a manner that the volume of the measuring chamber increases. In the case of under pressure, the separator membrane moves in the opposite direction, whereby the volume of the measuring chamber is reduced. In order to facilitate a movement of the separator membrane, it can be supported with its one or two sides on an elastic ring 17 that thus additionally ensures the tightness of the measuring chamber, as shown in FIG. 1. The material of the ring must substantially be adapted to the fluid to be used and, at the same time, provide a sufficient elasticity in order not to prevent the movement of the membrane. In this manner, simple materials such as silicone rubber, nitrile rubber (NBR), or generally thermoplastic polymers (TPE) can be used, as well as special materials from certain manufacturers, comprising Viton® or Calrez® (fluoric elastomer or perfluoric rubber from DuPont). Metal seals, i.e. from copper, are less suitable due to their stiffness. The pressure sensor membrane 18 is mounted or seated at the side of the separator membrane that opposes the fluid. It can e.g. consist of a piezoelectric material, so that upon movement of the separator membrane it generates corresponding voltage signals. These are guided by means of electric conduits 19 and 20 that are located at the upper and lower side of the pressure sensor membrane through an opening 21 to the outside, where they can be evaluated by means of a measuring electronics 2.

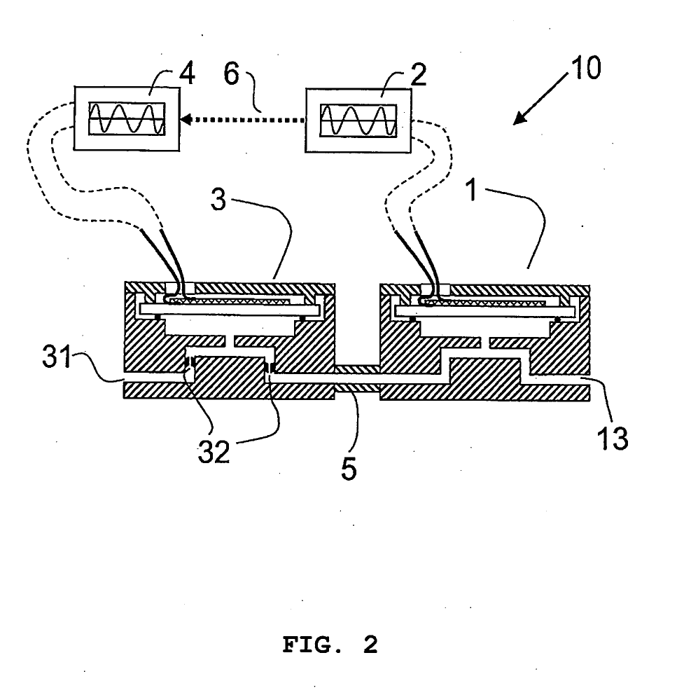

FIG. 2 shows the pressure sensor unit 1 of a volume flow sensor according to the presented principle with the unit being downstream of a fluid delivery device 3. In the drawing, the pressure sensor unit is downstream of the delivery device; however, an upstream arrangement is possible as well. Typically, this delivery device is a pump, in particular a micro pump. Both elements are in fluidic communication by means of a connector element 5. The common inlet is formed by the inlet 31 of the pump, while the common outlet corresponds to the outlet 13 of the pressure sensor unit.

As can be taken from FIG. 2, the pump 3 and the pressure sensor unit 1 can be fabricated with virtually identical components. This is advantageous under certain conditions, e.g. for the provision of a minimal number of components during the parallel fabrication of both systems, but by no means mandatory. Furthermore, it can be taken from FIG. 2 that the only constitutive difference between pump and pressure sensor unit is the presence of valves 32 in the pump system 3 and the lack of the same in the pressure sensor system 1. However, it is to be understood that the absence of valves in the pressure sensor system is not relevant for its functioning, but rather can be envisioned for economic reasons.

The evaluation electronics 2 allocated to the pressure sensor unit 1, and the control electronics 4 of the pump system 3 are shown as well. The transfer of the measuring signal of the pressure sensor unit to the control electronics is indicated by a dashed arrow 6, thereby enabling an automatic control of the volume flow by means of the control loop pump-pressure sensor.

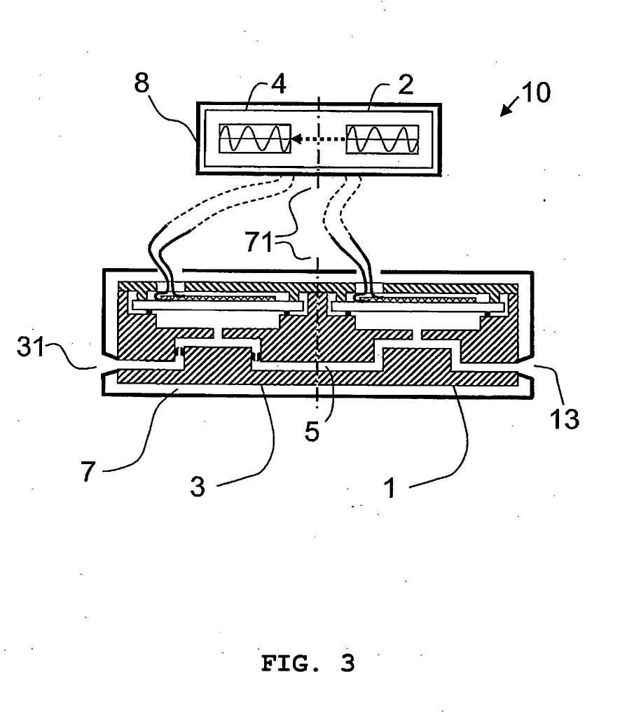

FIG. 3 shows an advantageous and therefore preferred embodiment of the proposed volume flow sensor system 10. Here, the pressure sensor unit 1 is integrated into the housing of a suitably designed pulsating fluid delivery device 3. The components that are required for the assembly of the pump and pressure sensor unit are largely identical. The fluidic systems of pressure sensor unit 1 and pump 3 can structurally be arranged in a common housing 7. The conceptual functional separation of both systems is indicated by the vertical dash-dotted line 71. The connector element 5 now merely consists of a simple channel; further fluidic interfaces for the coupling of both systems are no longer necessary. The measuring electronics 2 and the control electronics 4 of the complete system 7 are as well integrated into a housing 8. The electronic connection of both systems can preferably be realized up to an integration of the circuits onto a circuit board, or even into a semiconductor chip (e.g. a high performance ASIC; ASIC=Application Specific Integrated Circuit).

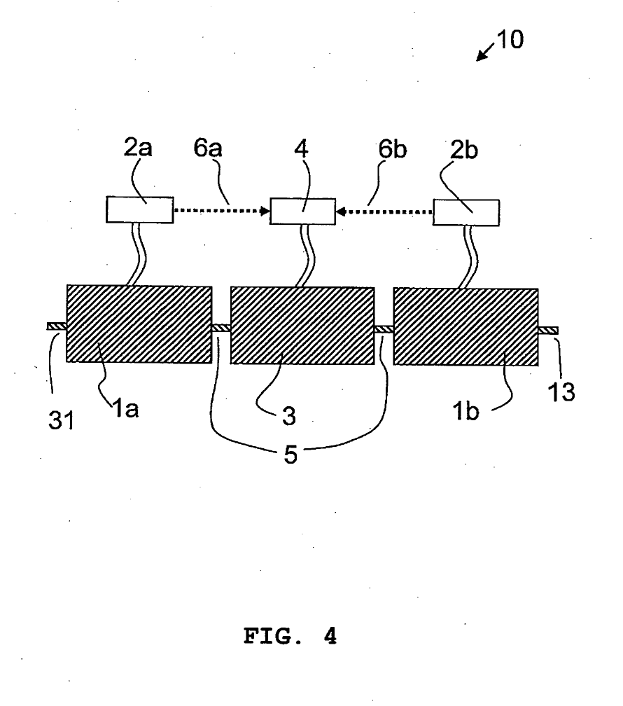

FIG. 4 shows a combination of a pump 3 with an upstream and downstream pressure sensor unit 1a, 1b. As with the aforementioned variants, the pump is connected to a control electronics 4, and each pressure sensor unit is connected with an evaluation electronics 2a or 2b, respectively. A coupling of the control electronics with the evaluation electronics is indicated by arrows 6a, 6b. The fluidic systems are connected with each other by means of connector elements 5. An inlet 31 and an outlet 13 can be assigned to the complete system 10.

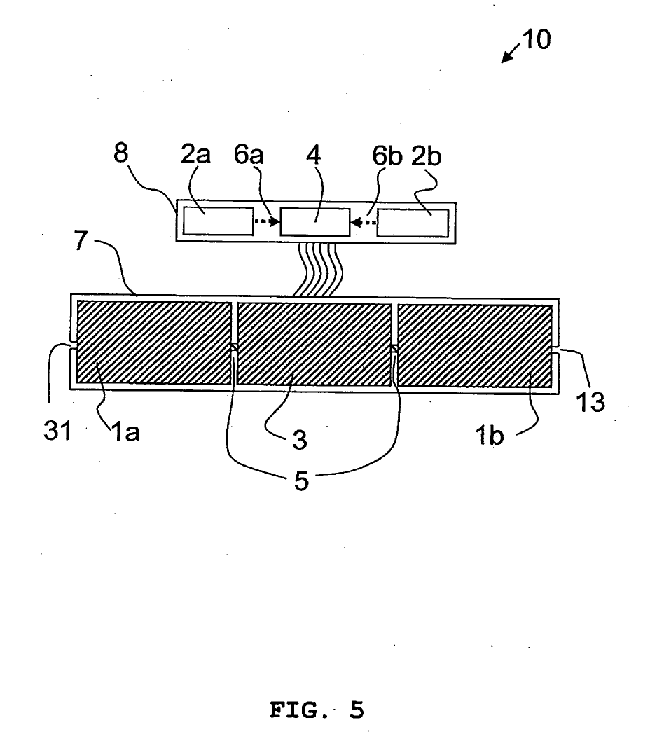

In analogy to FIGS. 2 and 3, respectively, FIG. 5 depicts an integrated variant of the combination as of FIG. 4 of a pump 3 and an upstream and downstream pressure sensor unit 1a or 1b, respectively. The terms correspond to those mentioned before, while the integrated housing 7 and the integrated control and evaluation electronics 8 are added.

The combination shown offers the previously mentioned advantages such as saving of housing volume, integration of electronics, and simple, parallel assembly.

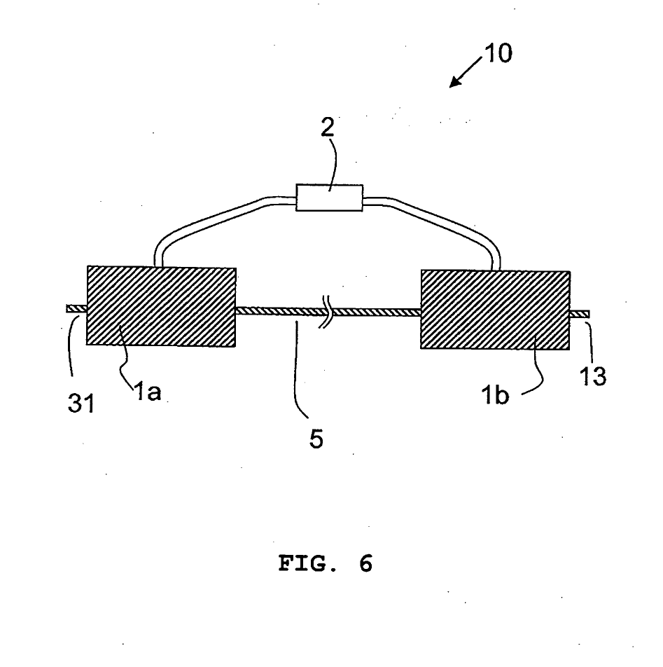

FIG. 6 schematically shows the assembly of a volume flow sensor according to the invention, which does not provide a possibility to directly use the control signals of an existing pulsation source 3. It consists of two pressure sensor units la and 1b that are located downstream of the pulsation source and allow for the determination of the pressure patterns at the same time at different sites. The first pressure sensor unit 1a that is located closer to the (not depicted) pulsation source delivers the signal 1, whereas the second pressure sensor unit that is located farther away from the pulsation source delivers the signal 2. Both signals are merged via signal conduits in a common evaluation unit 2.

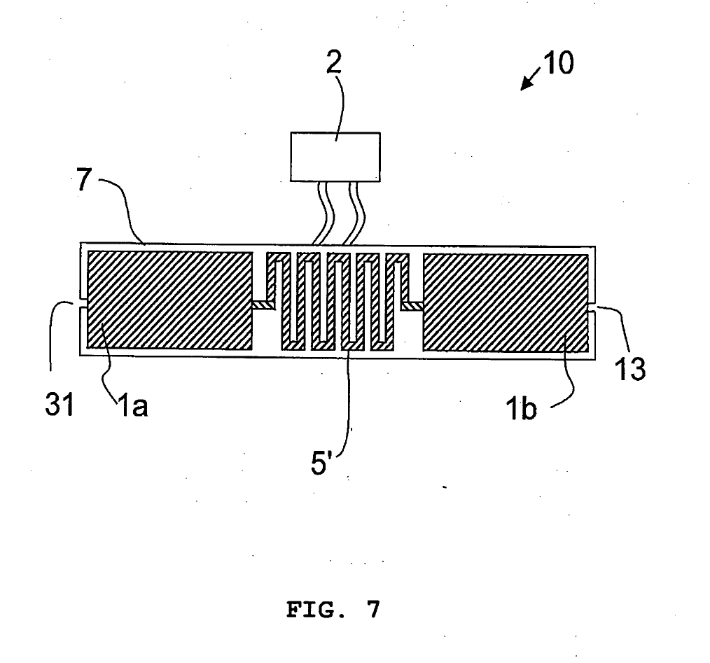

FIG. 7 shows the setup depicted in FIG. 6 as an integrated variant. Both pressure sensor units 1a and 1b are combined in a common housing 7. It can be necessary to artificially increase the distance between the pressure sensor units 1a and 1b, because the pressure pattern changes in dependence of the distance to the pulsation source and a well measurable difference between both signals is only present with a certain distance between the measuring sites. This can e.g. be achieved by the indicated fluidic spacer 5′, which is arranged between the pressure sensor units.

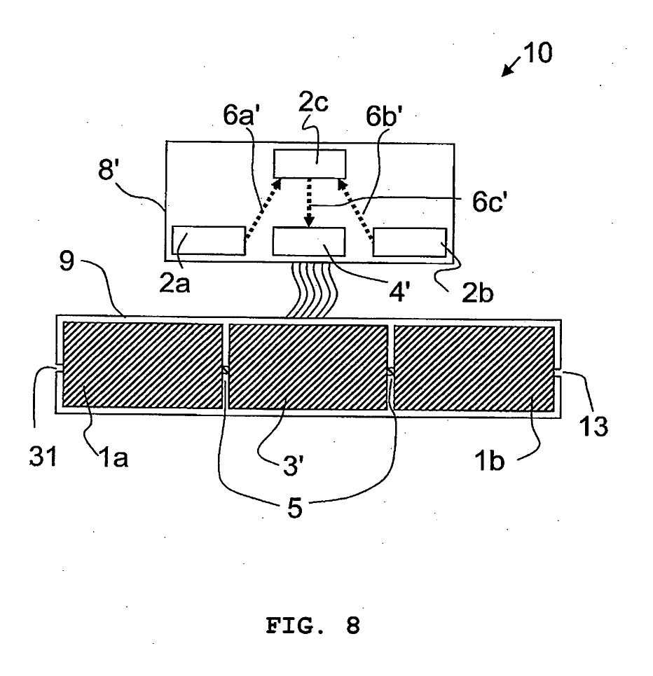

FIG. 8 schematically shows the setup of a volume flow measurement system 10 that consists of two pressure sensor units 1a, 1b described hereinabove, and a modified delivery device 3′, which preferably is constructed from elements identical to the pressure sensor units. In a particularly preferred embodiment, the modified pump 3′ is constructed identical to the pressure sensor units 1a and 1b, while it is merely operated in the actuator mode instead of the measuring mode used for the pressure sensor units. It is thus supplied with a cyclically changing voltage that excites the piezoelectric layer 18 of the membrane composite and, together with the separator membrane 16, results in a curvature of the same.

The substantial elements of such a system are two pressure sensor units 1a and 1b, between which a modified pump 3′ is arranged. In contrast to the pump shown in FIG. 2, this pump does not comprise valves 32, so that, upon excitation of the membrane, it merely generates a pulsation that, however, does not result in a net transport of fluid, since the fluid, upon pressure increase due to the modified pump, can escape in both connection channels 5 and, during the subsequent pressure reduction, flows back again from both connection channels 5 into the pumping chamber of the modified pump 3′. These pressure fluctuations can be measured with the pressure sensor units that are positioned up- and downstream of the modified pump. Further elements are the measuring and evaluation electronics 8′ that, in contrast to the integrated control and measurement electronics 8, does not comprise any direct feedback between the pressure sensor units and the modified actuator control 4′. Instead, an evaluation unit 8′ collects all data for the pumpless measuring system and generates a numeric value for the volume flow according to the invention.

In the case of a standing fluid, with no fluid flow through the system enforced from the outside, both pressure sensor units (with identical geometries, fluidic resistances of the channels etc.) measure an identical signal.

If a fluid to be measured streams in through the inlet 31, the measuring pulsation is superimposed by the flow of the measuring fluid. This results in a shift of the originally symmetric measuring signals. The faster the fluid to be measured streams, the more pronounced the shift is. Furthermore, the streaming fluid supports the movement of the actuator membrane in the direction in which the measurement chamber becomes larger and hinders the movement in the opposite direction. This results in an increase of the amplitude of the positive half-wave and in a decrease of the amplitude of the negative half-wave in the downstream pressure sensor unit 1b. This corresponds to a displacement of the mean value of the curve in positive direction. Contrary, the positive half-wave of the curve decreases, whereas the negative half-wave increases in case of an upstream pressure sensor unit 1a. This corresponds to a displacement of the mean value towards negative values.

A reversion of the stream direction results in correspondingly reversed displacements of both pressure sensor patterns.

FIG. 9 shows the control signal 100 of the pump or the pulsation device, respectively, and the pressure sensor signal 200 of the pressure sensor unit for the case in which the pump or the pulsation device is operated significantly below the resonance frequency of the pressure sensor unit.

For the sake of a better visualization, the scaling of both curves is adapted to each other. Normally, the amplitude of the control and measuring signal voltages can differ more clearly from each other.

At a (arbitrarily defined) time t₀ the pump or pulsation cycle starts, e.g. with a control voltage of 0 V or with a voltage that is at the beginning of the rising edge 101 of the control curve. Depending on the system, also the signal of the pressure sensor unit (measuring signal), either at the same time or at different times, begins to move from its base line 201 in positive direction. The peak of the measuring signal 202 is delayed with respect to the rising edge of the control signal 101 by a value Δt₁. The position of these two points of reference (101 and 202 in the example) can, however, be chosen arbitrarily at first, and should preferably be carried out in such a way that the determination of the times and the corresponding amplitudes can be effected as secure as possible and reproducible in each cycle.

Since the pump or pulsation frequency is relatively low, the pressure impulse 210 (shown hatched) that represents the pressure sensor signal backs down. Accordingly, no more fluid is delivered after the impulse until the cycle restarts again. Upon switching off the control voltage 102, a negative impulse 211 occurs at the pressure sensor unit, which is the smaller, the better the backlash stability of the valves used in the pump is. In this manner, the valve as an important pump element can thus be evaluated and controlled. If one of the valves becomes stuck, or if it doesn't close properly anymore e.g. due to contamination, the level of the backlash impulse 211 changes towards higher values, indicated by the dashed line 211.

By means of further parameters h₂ᵢ and/or Δtᵢ exemplarily depicted in FIG. 9, which allow for a parameter-based description of the profiles for example by means of the amplitudes and the corresponding times, it is possible with the aid of a few relevant data sets to detect important changes in the profile and to draw conclusions concerning the corresponding delivery rates.

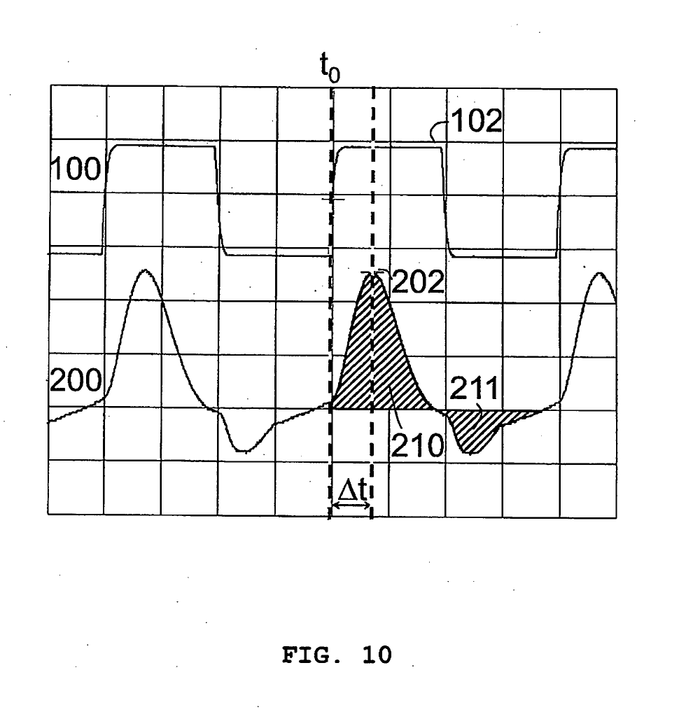

FIG. 10 shows the control signal 100 of the pump and the pressure sensor signal 200 of the pressure sensor unit for a frequency slightly below the resonance frequency of the pressure sensor unit.

The reduced cycle time of a pump or pulsation cycle can be read from the number of time units that are necessary for the completion of an entire cycle, indicated by the number of the correspondingly passed vertical subdivisions of the timescale. While in FIG. 9, approximately 8 time units are required for one cycle consisting of equally long control and dwell phases of the pump or pulsation device, the number of the time units in FIG. 10 is only halved, which is equivalent with the control frequency of the pump or the pulsation device being doubled.

Again, a cycle begins at time t₀, indicated by the first vertically dashed line. The time Δt₁ between the beginning of the pump or pulsation cycle and the reaching of the peak 202 of the pressure sensor signal is identical to the case described before, since up to this moment there is no difference to the case described before when viewed from the perspective of the pressure sensor unit.

Again, the negative half-wave 211 temporally coincides with the switching-off of the actuator voltage 102. The magnitude of the half-wave 211 differs from the one shown in FIG. 9, since the system is now closer to the resonance frequency. Since the valves each have to switch from the open to the closed state, less time is available for the switching due to the cycle time being shorter than in the previous case. On a relative basis, the closing requires a slightly longer time than with a frequency significantly below the resonance frequency, and a larger pressure pulse is visible in the outlet. The magnitude of the positive half-wave 210 is, however, practically identical to the half-wave shown in FIG. 9. The reason corresponds to the one that is quoted in the previous paragraph for the identity of Δt₁ in both drawings.

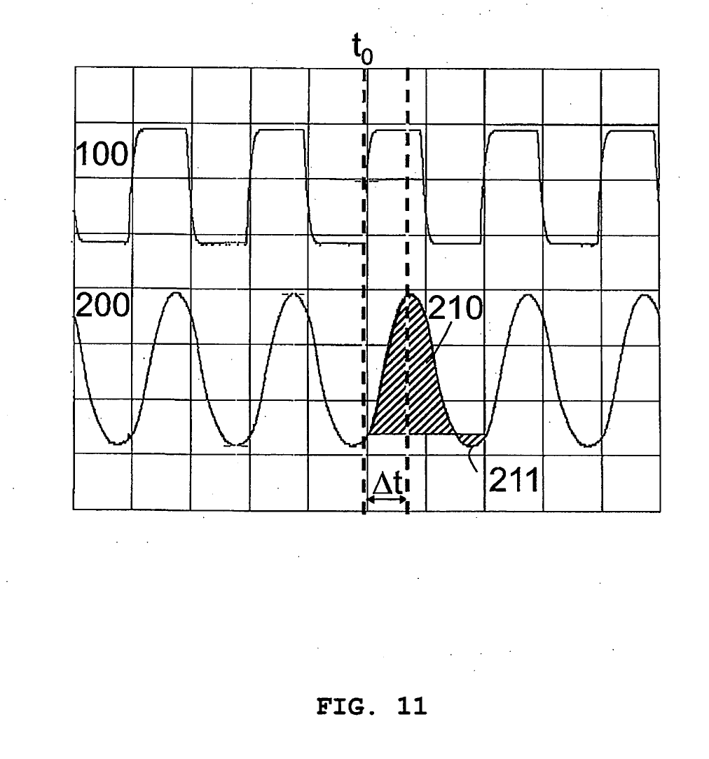

In FIG. 11, the fluid delivering pump is operated in the resonance frequency. The number of time units for one cycle is again reduced by a factor of 2 with respect to the case illustrated in FIG. 10. The time Δt₁, by which both peaks of curves 100 and 200 are shifted with respect to each other, is identical to the preceding cases. In terms of size and shape, the magnitude of the positive half-wave 210 also hardly differs from the previously described cases. The negative half-wave 211, on the other hand, is significantly smaller, also indicating a particularly effective pumping when operating in resonance mode.

FIG. 12 shows a comparison of the control and pressure sensor curve from FIG. 9 (normal operation) with the pressure sensor curve 200′, in which a gas bubble is present in the system between the delivery device and the pressure sensor unit. The actuator membrane receives the signals 100 that are necessary for operation; however, in contrast to a gas bubble free operation 200 with the signal amplitude h₁, the pressure sensor membrane emits a signal 200′ that is strongly reduced in its amplitude h₂ being due to the fact that the pump or the pulsation capacity is substantially used for a reversible compression of the gas bubble, which, in contrast to the fluid, is not incompressible and stores and re-emits the pressure pulse of the actuator in form of spring energy, without any relevant amount of fluid being delivered. The detection of the presence of such a disturbance can reliably be effected by evaluation of the amplitude of the sensor signal.

FIG. 13 shows (in idealized form) the process of the detection, the driving-out, and the re-testing of the presence of a gas bubble. Here, the pulsation generating unit is identical with the delivery unit, whose control signals are available. In a first phase I the pump operates normally and no disturbance of the pressure sensor signal 200 is detected (signal amplitude h₁). In a phase II, a strongly reduced signal amplitude h₂ is measured indicating the presence of a gas bubble. In a subsequent phase III, the pressure sensor is used as an actuator and receives an active signal 300 (voltage surge). For the optimal support of the pump signal 100, the signal 300 can be shifted by a value Δt′, wherein the value for Δt′ can be determined e.g. by experiments. In the subsequent test phase IV, the actuator signal is switched off, and it is tested by means of the signal level of the pressure sensor if the same has again returned to normal. If this is not the case, the phases III and IV are repeated (III′, IV′) until the pressure sensor signal has again returned to normal.

In addition to the indicated signal waveform of the sensor-actuator, other signal waveforms can also be used (sawtooth, Dirac impulse, increased or reduced frequency, etc.) if these provide better results. Also, the pump and the actuator signals may be coupled for a better adjustment and/or a better driving-out effect. In this context, a feedback of the signal of the pressure sensor unit can be effected in such a manner, that the pump upon detection of a gas bubble by the pressure sensor unit temporarily operates for example with a higher frequency and/or amplitude.

### LIST OF REFERENCES

1 detector, pressure sensor system
1a first pressure sensor unit
1b second pressure sensor unit
2 measuring/evaluation electronics
2a evaluation electronics for the first pressure sensor
2b evaluation electronics for the second pressure sensor
2c evaluation electronics for the pump-less measuring system
3 fluid delivery device, pump system
3′ modified pumping system without valves
4 control electronics for the fluid delivery device
4′ control electronics for the modified fluid delivery device
5 fluidic connector element
5′ fluidic spacer element
6 signal feedback
6a signal feedback of the upstream pressure sensor
6b signal feedback of the downstream pressure sensor
6a′ signal path of the upstream pressure sensor
6b′ signal path of the downstream pressure sensor
6c′ signal path of the control electronics for the pulsation
7 integrated housing
8 integrated control and measurement electronics
8′ integrated electronics for a measuring system without pump
9 integrated housing for a pump-less measuring system
10 volume flow sensor
11 inlet
12 measuring channel
13 outlet
14 cross channel
15 measuring chamber
16 elastically deformable separator membrane
17 support and seal ring
18 pressure sensor membrane/pressure sensor layer/measuring membrane
19 electric conduit
20 electric conduit
21 opening of housing
31 inlet of the fluid delivery device
32 valves of the fluid delivery device
71 system separation line between delivery device and sensor
100 control signal of the pump
101 rising edge of the control voltage (switching-on of pump)
102 trailing edge of the control voltage (switching-off of pump)
200 pressure sensor signal of the flow sensor
200′ pressure sensor signal of the flow sensor with a gas bubble being present
201 baseline of the pressure sensor signal
202 peak of the pressure sensor signal
210 pressure impulse of the pump, measured at the pressure sensor
211 negative impulse at the pressure sensor signal by closing the valve

1. Method for the ascertainment of a fluid quantity that streams pulsating through a channel by comparison of the profiles of at least two signals, which are related to a pulsational pressure change of the fluid stream and which are ascertained either at the same time at non-identical sites of the fluid stream or at different times at one site of the fluid stream.

2. Method according to claim 1, characterized in that the comparison is based on the curve progressions of the profiles and/or on single or multiple parameters thereof.

3. Method according to claim 1 or 2, wherein a first signal is provided by:
(a) the signal for the control of the pulsation device, by which the fluid quantity streaming through the channel is put into pulsation; or
(b) a sensor for the ascertainment of the pressure condition of the fluid quantity that streams pulsating through the channel; or
(c) a standard value;
and wherein a second signal is provided by a pressure sensor that is located downstream.

4. Method according to claim 1, wherein the profile that results from a signal relates to the course of a signal within one pulsation period and comprises parameters selected from the group consisting of positive amplitude, negative amplitude, slope of the positive edge, slope of the negative edge, time of the different zero crossings, and combinations thereof.

5. Method according to claim 1, wherein the profile comparison is performed to detect disturbances in the fluid stream.

6. Apparatus for carrying out the method as defined in claim 1.

7. Apparatus for the ascertainment of a fluid quantity that streams pulsating through a channel by comparison of the profiles of two signals, which are related to a pulsational pressure change of the fluid stream and which are ascertained at the same time at non-identical sites of the fluid stream or at different times at one site of the fluid stream, wherein the apparatus comprises at least one detector for the ascertainment of an input quantity and for the transformation into an output quantity, which is built by an elastically deformable membrane that is fixed with respect to the fluid carrying channel and that is in contact with the fluid at least along one side, wherein the membrane is fluidically sealed along its circumference against the channel.

8. Apparatus according to claim 7, characterized in that it comprises an evaluation unit for further processing of the output quantity.

9. Apparatus according to claim 7, characterized in that the input quantity to be detected is the pressure of the fluid quantity streaming through the channel at a certain measuring site.

10. Apparatus according to claim 9, characterized in that the output of the at least one detector provides an electrical signal.

11. Apparatus according to claim 10, characterized in that it comprises an elastically deformable membrane of the at least one detector in the form of a piezoelectric layer.

12. Apparatus according to claim 10, characterized in that the elastically deformable membrane is covered with a piezoelectric layer.

13. Apparatus according to claim 11, characterized in that the elastically deformable membrane comprises the characteristics of an actuator.

14. Apparatus according to claim 10, characterized in that it further comprises a pulsation device.

15. Apparatus according to claim 14, characterized in that the pulsation device comprises a piezo-actuated membrane.
